(19) United States
(12) Patent Application Publication
(10) Pub. No.: US 2012/0187013 A1
(43) Pub. Date: Jul. 26, 2012

(54) VEHICLE BOX LID ORGANIZER

(76) Inventor: Albert Gapinski, Boulder, CO (US)

(21) Appl. No.: 13/012,908

(22) Filed: Jan. 25, 2011

(51) Int. Cl. B65D 25/04; B60R 9/00; B65D 85/00

(52) U.S. Cl. 206/373; 220/522; 224/404

(57) ABSTRACT

The invention provides a truck box lid organizer assembly removably connected to a truck box lid. The truck box lid organizer including storage pockets. The truck box lid organizer is connected to an inner portion of the truck box lid via fastening elements.

### BACKGROUND

1. Field

The embodiments relate to vehicle storage boxes, and in particular to an apparatus, method and system for vehicle storage box lid organizers.

2. Description of the Related Art

Vehicle storage boxes are used by many tradesmen, business owners and homeowners for various tasks. Many times a person using a vehicle box, such as a pickup truck box, stores tools and accessories in the box. Since the box is attached to the bed of the vehicle, even though the box may be enclosed, the tools and accessories, et al., may move around inside the box. This leads to disorganization of the items in the box, possible damage, possible spillage of items, such as paint, etc. With the movement of the articles inside a vehicle box due to the motion of the vehicle, time is often wasted by a user trying to locate specific items, especially small items (e.g., nails, screws, small hand tools, etc.

### SUMMARY

One embodiment of the invention includes a vehicle box lid organizer. The vehicle box lid organizer including an organizer comprising a fold out portion and a stationary portion. The stationary portion including a plurality of pockets. An organizer exterior portion is configured for coupling to an inner portion of the vehicle box lid. A plurality of fastening elements are coupled to the organizer exterior portion and the inner portion of the vehicle box lid. The fastening elements secure the organizer to the inner portion of the vehicle box lid.

Another embodiment of the invention comprises a system including a truck box lid organizer assembly removably connected to a truck box lid. The truck box lid organizer includes at least one storage pocket. The truck box lid organizer is connected to an inner portion of the truck box lid via a means for fastening.

Yet another embodiment of the invention comprises a method of organizing a vehicle box. The method includes providing a vehicle box organizer including: a fold out portion and a stationary portion, the stationary portion including a plurality of pockets; an organizer exterior portion configured for coupling to an inner portion of a vehicle box lid; and a plurality of organizer fastening elements coupled to the organizer exterior portion. The method further includes attaching a plurality of vehicle box lid fastening elements to an interior of a vehicle box lid. The method also includes connecting the plurality of organizer fastening elements to the plurality of vehicle box lid fastening elements to attach the organizer to the vehicle box lid, and placing an assortment of objects into the plurality of pockets.

Other aspects and advantages of the present invention will become apparent from the following detailed description, which, when taken in conjunction with the drawings, illustrate by way of example the principles of the invention.

### BRIEF DESCRIPTION OF THE DRAWINGS

The embodiments are illustrated by way of example, and not by way of limitation, in the Figures of the accompanying drawings and in which like reference numerals refer to similar elements and in which:

FIG. 1 illustrates a front perspective view of a vehicle box lid organizer according to one embodiment of the invention:

FIG. 2 illustrates a front perspective view of a vehicle box lid organizer shown removed from a vehicle box lid according to one embodiment of the invention;

FIG. 3 illustrates a front perspective view of the embodiment illustrated in FIG. 1 showing a flap removed from a fold out portion of the vehicle box lid organizer;

FIG. 4 illustrates a front perspective view of the vehicle box organizer shown in FIG. 3 with the fold out portion unfolded according to another embodiment of the invention;

FIG. 5 illustrates a front perspective view of the vehicle box lid organizer shown in FIG. 4 with tools and accessories placed in the vehicle box lid organizer according to still another embodiment of the invention; and

FIG. 6 illustrates a block diagram of a process for organizing a vehicle box according to an embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of vehicle storage box organizers, as well as operation and/or component parts thereof. While the following description will be described in terms of vehicle storage box organizers and devices for clarity and to place the invention in context, it should be kept in mind that the teachings herein may have broad application to all types of systems, devices and applications.

One embodiment of the invention provides a vehicle box lid organizer including an organizer comprising a fold out portion and a stationary portion. The stationary portion including a plurality of pockets. An organizer exterior portion is configured for coupling to an inner portion of the vehicle box lid. A plurality of fastening elements are each coupled to the organizer exterior portion and the inner portion of the vehicle box lid. The fastening elements secure the organizer to the inner portion of the vehicle box lid

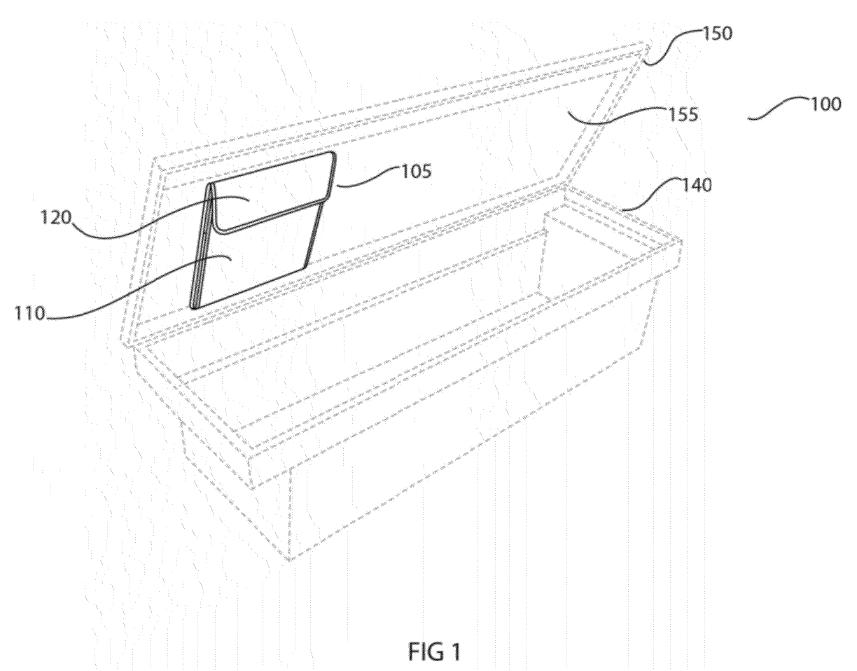

FIG. 1 illustrates a vehicle box lid organizer 100 for a vehicle (e.g., a truck, a boat, a service vehicle, emergency service vehicles, etc.) storage container or box, such as a vehicle box 140 with lid 150, according to one embodiment of the invention. Vehicle box lid organizer 100 includes lid organizer 105 including a fold out portion 110 and a securing flap portion 120. As illustrated, the lid organizer 105 is removably attached to an inner portion 155 of the vehicle lid 150. In one embodiment of the invention, the lid organizer 105 has a width or thickness less than or equal to the interior portion of the vehicle lid 150 so that the lid organizer 105 does not intrude into the vehicle box 140 storage portion when the vehicle lid 150 is closed onto the vehicle box 140 storage portion. In other embodiments, the lid organizer 105 has a width or thickness that intrudes into the vehicle box 140 storage portion when the vehicle lid 150 is closed onto the vehicle box 140 storage portion.

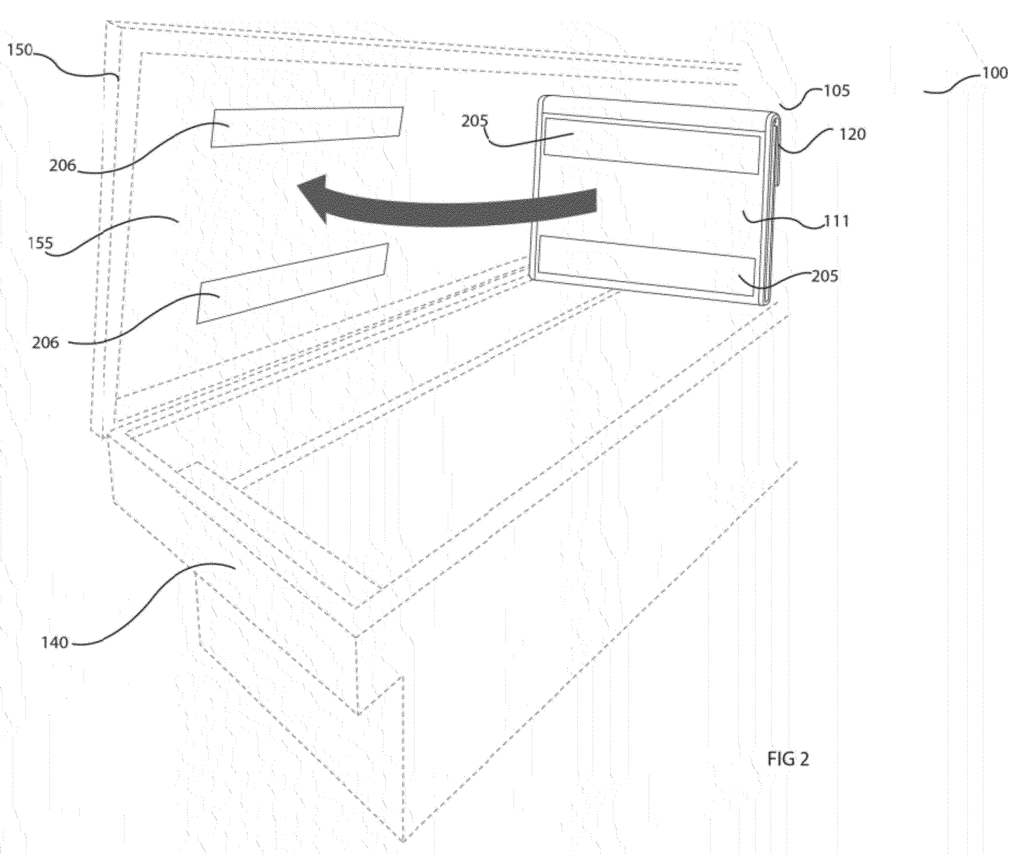

FIG. 2 illustrates a front perspective view of a vehicle box lid organizer 100 with the lid organizer 105 shown removed from the inner portion of the vehicle box lid 150 according to one embodiment of the invention. In one example, the exterior portion 111 of the lid organizer 105 includes means for fastening 205, and the inner portion 155 of the vehicle lid 150 includes other means for fastening 206. In one embodiment of the invention, the means for fastening includes fastening elements 205 and 206 that are hook and loop fasteners that couple with one another. In one example, the fastening elements 205 are attached to the exterior portion 111 via adhesive means, heat welding, stitching, etc. In another example, the fastening elements 206 are attached to the inner portion 155 via adhesive means. It should be noted that other embodiments of the invention include other complementary means for fastening, such as other fastening elements, e.g., snaps, connecting tracks removable locking means, etc.

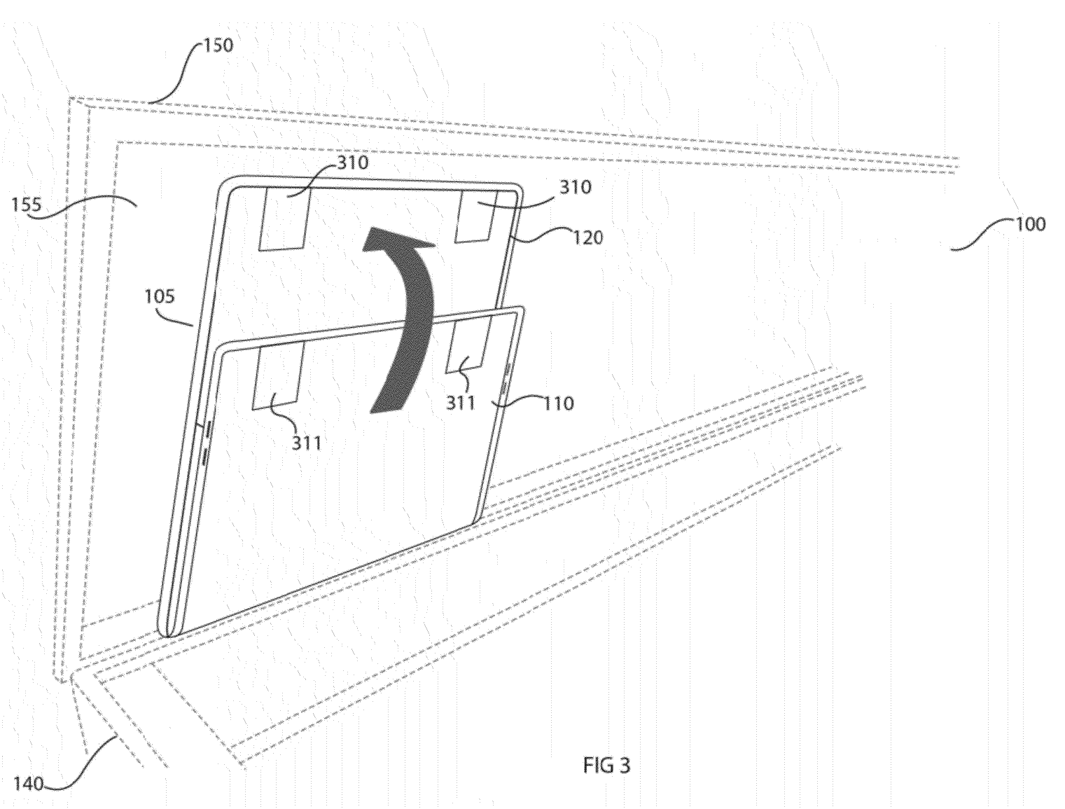

FIG. 3 illustrates a front perspective view of the vehicle box lid organizer 100 showing the securing flap portion 120 removed from the fold out portion 110 of the lid organizer 105. In one example, the flap portion 120 includes fastening elements 310, and the fold out portion 110 includes fastening elements 311. In one embodiment of the invention, the fastening elements 310 and 311 are hook and loop fasteners that couple with one another. In one example, the fastening elements 311 are attached to the exterior portion of fold out portion 110 via stitching, adhesive means, heat welding, etc. In another example, the fastening elements 310 are attached to the inner portion of flap portion 120 via stitching, adhesive means, heat welding, etc. It should be noted that other embodiments of the invention include other fastening elements, such as snaps, clips, key connectors, grooves, tracks, etc. As illustrated, the arrow shows the movement of the flap portion 120 as it is opened or moved away from the fold out portion 110.

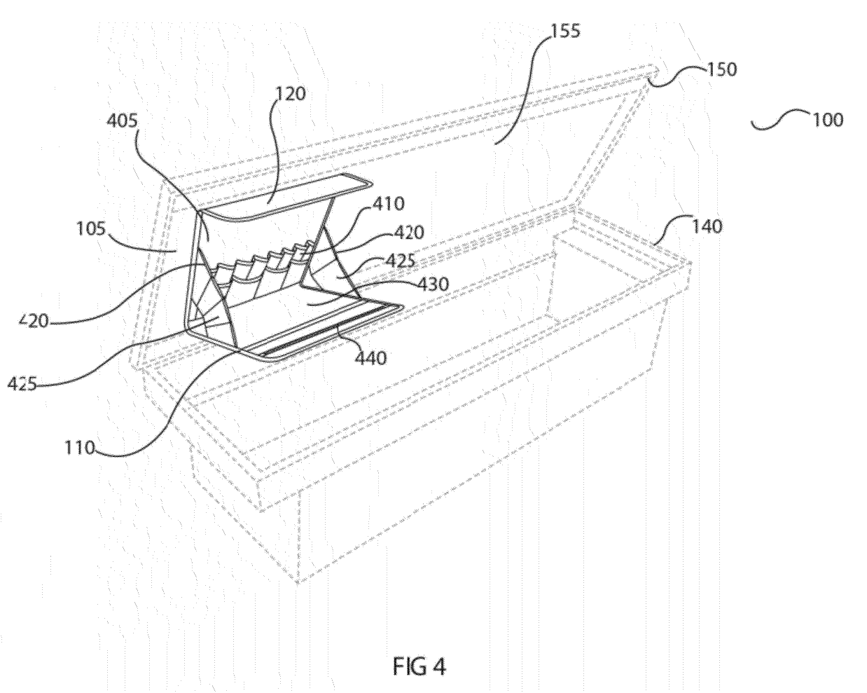

FIG. 4 illustrates a front perspective view of the vehicle box lid organizer 100 shown with the fold out portion 110 of the lid organizer 105 unfolded according to another embodiment of the invention. In one example, the flap portion 120 is shown coupled to a stationary portion 405 of the lid organizer 105. In one embodiment of the invention the lid organizer 105 includes extension portions 420 that limit the angle or distance the fold out portion 110 moves away from the stationary portion 405.

In one embodiment of the invention the extension portion 420 includes holders 425. In one example, the holders 425 are one or more pockets configured for holding accessories, such as pencils, small tools, etc. On another example, the extension portions 420 with holders 425 are collapsible and fold inward between the flap portion 120 and the fold out portion 110 when the lid organizer is placed in a closed state.

In one embodiment of the invention the stationary portion 405 includes one or more pockets 410. In one example, if more than one pocket, the pockets 410 are the same size. In one example, if more than one pocket, the pockets 410 may be sized in a variety of shapes and sizes in order to accommodate various tools, papers, workmen accessories, hardware, etc. In one embodiment of the invention, the pockets 410 are formed from additional material with stitching separating each adjacent pocket from one another.

In one embodiment of the invention the fold out portion 110 of the lid organizer 105 includes a tray portion 430 that may be substantially parallel to the truck box storage portion 140 when the fold out portion 110 is folded out away from the stationary portion 405 when the vehicle lid 155 is in the open state. In one embodiment of the invention, the tray portion 430 is reinforced with a material, such as hardened plastic, a metal or metal alloy, etc.

In one embodiment of the invention, the fold out portion 110 includes a hidden inner compartment 440. In one example, the inner compartment 440 is enclosed using a fastening means, such as a zipper, hook and loop connecting fasteners, etc.

In one example, the vehicle box lid organizer 100 elements are made of a nylon material and/or a canvas material. In another example, the lid organizer 105 may include elements made of hardened plastic, polymer materials, etc.

In one embodiment of the invention, the vehicle box lid 150 may vary in size. In one example, the left and right sides of the vehicle box lid 150 may range from 16 inches-24 inches, preferably between 16 inches-18 inches; and the front and rear sides of the vehicle box lid 150 may range from 40 inches-60 inches, preferably between 40 inches-48 inches across. It should be noted that the lid organizer 105 may he customized and fit according to necessity and desire of the user.

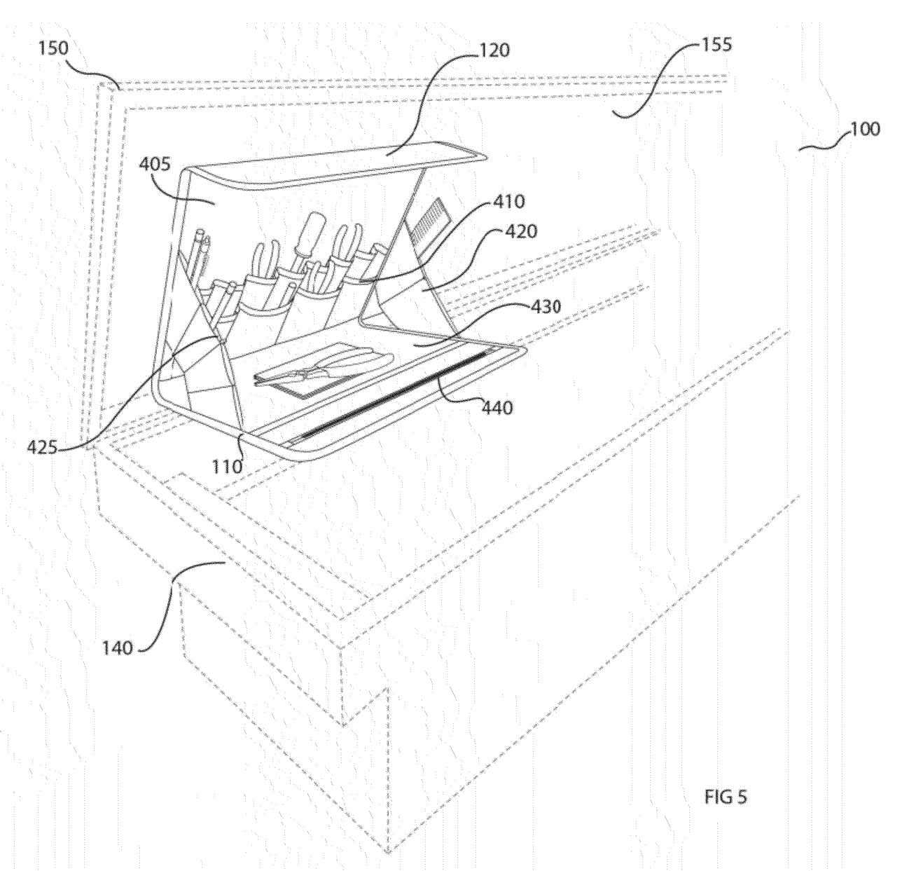

FIG. 5 illustrates a front perspective view of the vehicle box lid organizer 100 shown with tools and accessories placed in the lid organizer 105 according to still another embodiment of the invention.

In one embodiment of the invention, the lid organizer 105 includes reinforcement coupling portions around the perimeter and corner or joining portions of the stationary portion 405 and the fold out portion 110. In one example, the reinforcement coupling portions are made of a material, such as canvas, synthetic leather, leather, nylon, metal or metal alloy, etc. In one example, the reinforcement coupling portions are connected to the lid organizer 105 walls by stitching. In other examples, the reinforcement coupling portions are attached through other fastening means, such as rivets, screws, nuts/bolts, heat welding, adhesives, etc.

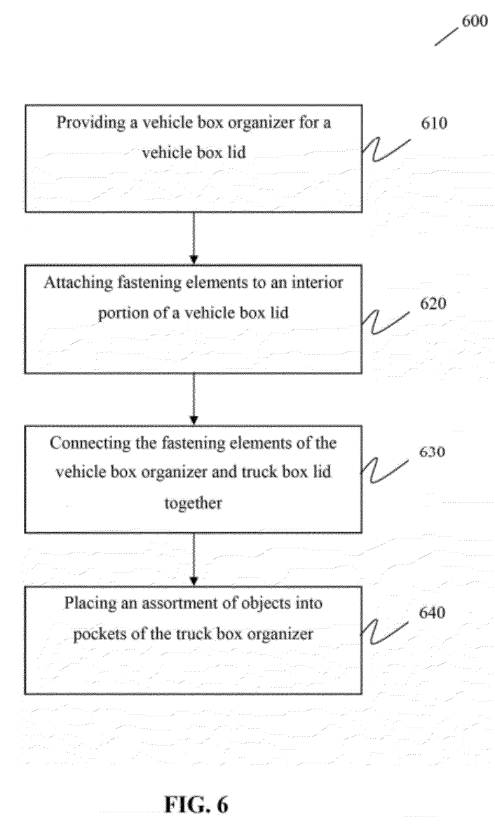

FIG. 6 illustrates a block diagram of a process 600 for organizing a vehicle box according to one embodiment of the invention. In block 610, a vehicle box organizer for a vehicle box lid is provided, such as vehicle box lid organizer 100, for a vehicle box lid, for example, vehicle box lid 150. In block 620, fastening elements, such as fastening elements 206, are attached to an interior of a vehicle box lid. In block 630, the truck box lid organizer provided in block 610 is inserted onto a truck box lid, such as vehicle box lid 150 by connecting fastening elements of the vehicle box lid organizer and vehicle box lid together. In block 640, an assortment of objects, such as tools, accessories, hardware, etc., are placed into storage pockets of the truck box lid organizer.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A vehicle box lid organizer comprising:
an organizer including a fold out portion and a stationary portion, the stationary portion including a plurality of pockets;
an organizer exterior portion configured for coupling to an inner portion of a vehicle box lid; and
a plurality of fastening elements coupled to the organizer exterior portion and the inner portion of the vehicle box lid,
wherein the fastening elements secure the organizer to the inner portion of the vehicle box lid.

2. The vehicle box lid organizer of claim 1, further comprising an extension portion coupled to the fold out portion and the stationary portion.

3. The vehicle box lid organizer of claim 2, wherein the extension portion is configured to fold inward between the stationary portion and the fold out portion.

4. The vehicle box lid organizer of claim 2, wherein the extension portion including a plurality of collapsible holders.

5. The vehicle box lid organizer of claim 4, further comprising:
a flap portion coupled to the stationary portion, wherein the flap portion is removably coupled to an exterior of the fold out portion.

6. The vehicle box lid organizer of claim 5, wherein the flap portion is configured for securing the fold out portion when coupled to the fold out portion.

7. The vehicle box lid organizer of claim 6, further comprising:
an inner compartment disposed within the fold out portion.

8. The vehicle box lid organizer of claim 6, wherein the fold out portion is configured for folding out away from the stationary portion at an angle so that the fold out portion becomes parallel to a storage portion of the vehicle box.

9. The vehicle box lid organizer of claim 6, wherein the organizer is configured for having a width less than a width of an inner portion of the vehicle box lid.

10. The vehicle box lid organizer of claim 8, wherein the organizer is removably coupled with the inner portion of the vehicle box lid.

11. The vehicle box lid organizer of claim 8, wherein the plurality of fastening elements are hook and loop fasteners.

12. The vehicle box lid organizer of claim 11, wherein the plurality of fastening elements coupled to the organizer exterior portion and the inner portion of the vehicle box lid are attached with adhesive.

13. A system comprising:
a truck box lid organizer assembly removably coupled to a truck box lid;
the truck box lid organizer including at least one storage pocket, wherein the truck box lid organizer is coupled to an inner portion of the truck box lid via a means for fastening.

14. The system of claim 13, further comprising an extension portion coupled to a foldout portion and a stationary portion of the truck box lid assembly, wherein the extension portion is configured to fold inward between the stationary portion and the fold out portion, and a flap portion is coupled to the stationary portion, wherein the flap portion is removably coupled to an exterior of the fold out portion.

15. The system of claim 14, wherein the extension portion including a plurality of collapsible holders.

16. The system of claim 15, wherein means for fasting comprises a plurality of fastening elements.

17. The system of claim 15, further comprising:
an inner compartment disposed within the fold out portion, wherein the fold out portion is configured for folding out away from the stationary portion at an angle so that the fold out portion becomes parallel to a storage portion of the truck box.

18. The system of claim 17, wherein the truck box lid organizer assembly is configured for having a width less than a width of an inner portion of the truck box lid.

19. The system of claim 13, further comprising a plurality of storage pockets.

20. A method of organizing a vehicle box comprising:
providing a vehicle box organizer including:
a fold out portion and a stationary portion, the stationary portion including at least one storage pocket;
an organizer exterior portion configured for coupling to an inner portion of a vehicle box lid; and
a plurality of organizer fastening elements coupled to the organizer exterior portion;
attaching a plurality of vehicle box lid fastening elements to an interior of a vehicle box lid;
connecting the plurality of organizer fastening elements to the plurality of vehicle box lid fastening elements to attach the organizer to the vehicle box lid; and
placing an assortment of objects into the plurality of pockets.
